(19) United States
(12) Patent Application Publication
(10) Pub. No.: US 2009/0074276 A1
(43) Pub. Date: Mar. 19, 2009

(54) Voxel Matching Technique for Removal of Artifacts in Medical Subtraction Images

(75) Inventors: Kunio Doi, Willowbrook, IL (US); Shigehiko Katsuragawa, Oita (JP); Yoshinori Itai, Oita (JP); Hyoungseop Kim, Kitakyushu (JP)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: THE UNIVERSITY OF CHICAGO, Chicago, IL (US)

(21) Appl. No.: 12/233,031

(22) Filed: Sep. 18, 2008

Related U.S. Application Data
(60) Provisional application No. 60/973,615, filed on Sep. 19, 2007.

(51) Int. Cl. G06K 9/00

(52) U.S. Cl. 382/130

(57) ABSTRACT

A method for improving the alignment accuracy between different medical images may be disclosed. A warped or non-warped previous image and a warped or non-warped current image may include a plurality of respective previous and current basic units, for example, pixels in a 2-dimensional image or voxels in a 3-dimensional image. To ensure accurate registration between the previous and current images, a first basic unit from the previous image may be replaced by a second basic unit from the current image if the value of the first and second basic units are identical or nearly identical. The first and second basic units may be selected from a nearly-identical region or “kernel” within the previous and current images.

### RELATED DOCUMENTS

The present application claims the benefit of U.S. Provisional Patent Application No. 60/973,615 filed on Sep. 19, 2007, the entire disclosure of which is hereby incorporated by reference.

### GOVERNMENT RIGHTS

This invention was made with government support under grant number CA98119 awarded by the National Institutes of Health (NIH). The government has certain rights in the invention.

### TECHNICAL FIELD

This patent relates to image analysis, and more particularly, to a technique for removing artifacts in medical subtraction images by voxel matching.

### BACKGROUND

Digital imagery and computer-aided diagnosis (CAD) has, in most instances, replaced film and other imaging techniques in the field of radiology. Because of their inherent portability, digital radiological images may be easily delivered and analyzed by radiologists and other medical professionals. For example, systems and methods that produce computed tomography (CT) images conforming to the Digital Imaging and Communications in Medicine (DICOM) standard are ubiquitous. Further, computer-implemented methods may assist or supplement the radiologist's analysis of these images during a patient's course of treatment.

Radiologists analyze CT images to detect subtle abnormalities. These abnormalities may appear in a CT image as an area of contrast that is incongruent with other image structures. However, small lesions, aneurysms, or other abnormalities that are extremely low in contrast may be difficult to discern because the abnormality (e.g., a small lung nodule, an intracranial aneurism, or other abnormality) may appear to be noise or even a portion of a normal structure. Further, workload and other constraints may decrease radiologists' ability to accurately analyze many CT images.

Temporal subtraction is a known method by which a radiologist may identify low contrast abnormalities. For example, a temporal subtraction image is obtained by subtracting the structures that are common to both a previous and a current CT image. The remaining structures enhance the interval changes, and thus, abnormalities, on medical images by the removal of most normal structures. Therefore, a radiologist's detection of new abnormalities and changes to existing abnormalities provides robust evidence for diagnosis. The temporal subtraction method is known to improve radiologists' diagnostic accuracy and reduce their reading time.

However, the temporal subtraction method commonly introduces further complications. For example, chest images such as chest radiographs and thoracic CT images commonly include artifacts from the subtraction method. The artifacts are created by slight differences in the size, shape, and/or location of anatomic structures such as blood vessels, nodules, chest walls, ribs, and other lung and cardiac structures that are included in both the current and previous images. Even differences as slight as one pixel in two-dimensional images and one voxel in three-dimensional images may cause disturbing subtraction artifacts in temporal subtraction images. The artifacts may be difficult to distinguish from new abnormalities or changes in existing abnormalities. Thus, it is desirable to remove these subtraction artifacts from temporal subtraction images.

If the anatomic structures of both a current and previous medical image were identical, then subtraction artifacts would disappear. However, changes in patient physiology, the position of the subject during the imaging process, and other factors make having identical current and previous images nearly impossible. To remedy positioning changes and other problems with temporal subtraction, an image warping technique may be applied to accurately deform or register the previous image to match the current image (or vice-versa). However, if the warping is inaccurate, normal structures will produce artifacts in the subtraction image and degrade the image quality.

Warping techniques for 2-dimensional (2-D) radiological images are known in CAD. However, few techniques exist for accurately warping 3-dimensional (3-D) images. For example, in temporal subtraction images obtained with multiple-detector CT (MDCT) volume images used in thoracic examinations, it is necessary to employ a more complex 3-D technique for registration and warping of lung regions between the current and previous images. Examples of previous 3-D image warping methods are disclosed in “Development of 3D CT temporal subtraction based on nonlinear 3D image warping technique,” by T. Ishida, S. Katsuragawa, H. Abe, K. Ashizawa, and K. Doi, Proc. The 91st Radiological Society of North America (RSNA), 111, Chicago, USA, 2005; “Temporal subtraction on 3D CT images by using nonlinear image warping technique” by T. Ishida, S. Katsuragawa, I. Kawashita, H. Kim, Y. Itai, K. Awai, Q. Li, and K. Doi, Int. J. CARS, 1, pp. 468, 2006; “3D elastic matching for temporal subtraction employing thorax MDCT image” by Y. Itai, H. Kim, S. Ishikawa, S. Katsuragawa, T. Ishida, I. Kawashita, K. Awai, Q. Li, and K. Doi, Proc. of the World Congress on Medical Physics and Biomedical Engineering, pp. 2181-2191, 2006; and “Development of temporal subtraction multislice CT images by using a 3D local matching with a genetic algorithm” by Y. Itai, H. Kim, S. Ishikawa, S. Katsuragawa, T. Ishida, and K. Doi, Proc. The 92nd Radio-logical Society of North America (RSNA), pp. 779, Chicago, USA, November 2006. Despite these known improvements in temporal subtraction imaging, misregistration or other image alignment inaccuracies introduced artifacts in subtraction image analysis using these and other prior techniques.

### SUMMARY

A method for improving the alignment accuracy between different medical images is disclosed. A warped or non-warped previous image and a warped or non-warped current image may include a plurality of respective previous and current basic units, for example, pixels in a 2-dimensional image or voxels in a 3-dimensional image. To ensure accurate registration between the previous and current images, a first basic unit from the previous image may be replaced or modified by a second basic unit from the current image if a value of the first and second basic units are identical or nearly identical. The first and second basic units may be selected from a nearly-identical region or “kernel” within the previous and current images.

### BRIEF DESCRIPTION OF THE DRAWINGS

FIG. 1 is an illustration of an exemplary computing system for use with the techniques described herein;

FIG. 2 is a flowchart illustrating an example of a portion of a method for creating a temporal subtraction image;

FIG. 3 is an example of a first or previous medical image;

FIG. 4 is an example of a second or current medical image;

FIG. 5 is an example of a temporal subtraction medical image without the basic unit matching technique applied;

FIG. 6 is a flowchart illustrating an example of another portion of a flowchart illustrating a method for creating a temporal subtraction image;

FIG. 7 is an example of a temporal subtraction image with the basic unit matching technique applied; and

FIG. 8 is another example of a temporal subtraction image with the basic unit matching technique applied.

### DETAILED DESCRIPTION

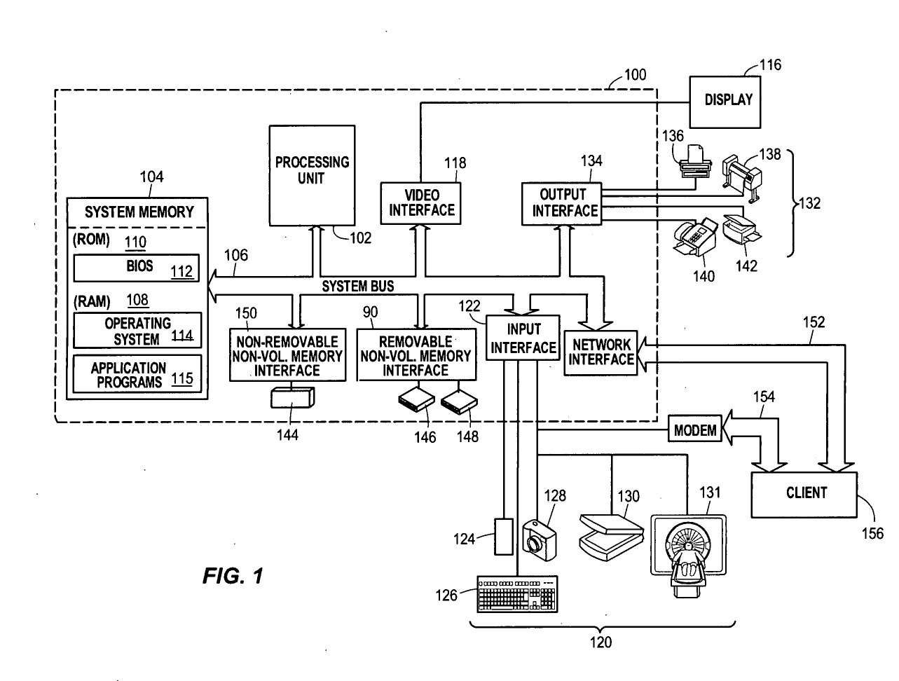

Referring to FIG. 1, a computer system 100 may include a processing unit (CPU) 102, for example, an Intel Pentium™ class microprocessor. One or more memory devices 104 may be connected to a bus 106, including random access memory (RAM) 108 and read only memory (ROM) 110. A basic input/output system (BIOS) 112, containing the routines that may transfer information between elements within the computer 100, is typically stored in ROM 110. RAM 108 typically contains immediately accessible program modules such as the operating system 114 or application programs 115 currently used by the CPU 102. A display 116 may be connected to the system bus 106 though a video interface 118. Input devices 120 may be connected to the system bus 106 though an input interface 122. Input devices 120 may include a mouse 124, a keyboard 126, a camera 128, a scanner 130, a Computed Tomography (CT) Scanner 131, or other image capture device. The CT Scanner 131 may be any type of medical imaging equipment employing tomography where digital geometry processing may be used to generate a 3-dimensional (3-D) image of the internal composition of an object from a series of 2-dimensional (2-D) X-ray or other radiological images taken around an axis of rotation. Output 132 devices may be connected to the system bus 106 through an output interface 134 and may include a printer 136, a plotter 138, a facsimile device 140, a photocopier 142, and the like.

The CT Scanner 131 and other specialized medical imaging equipment may be in communication with the computer system 100 to display anatomical information, such as anatomical information generated by a specialized imaging processes. For example, the anatomical information may be generated by various computed tomography (CT) techniques (e.g., computed axial tomography and CT angiography, etc.), Dynamic Contrast Magnetic Resonance Imaging (DCMRI), Magnetic Resonance Imaging (MRI), sonography (e.g., Ultrasound), positron emission tomography (PET), body section roentgenography, X-ray, or other processes.

The computer system 100 may include a computer-readable medium having a computer program or computer system 100 software accessible therefrom. The computer program may include instructions for performing methods. The computer-readable medium may be stored on a non-removable, non-volatile memory device 144 such as a hard disk, or a removable, non-volatile memory device such as a floppy disk drive 146 or an optical disk drive 148. The non-removable, non-volatile memory device 144 may communicate with the computer 100 system bus 106 through a non-removable, non-volatile memory interface 150. The computer-readable medium may include a magnetic storage medium (disk medium, tape storage medium, microdrives, compact flash cards), an optical storage medium (compact disks such as CD-ROM, CD-RW, and DVD), a non-volatile memory storage medium, a volatile memory storage medium, and data transmission or communications medium including packets of electronic data, and electromagnetic or fiber optic waves modulated in accordance with instructions. Thus, the computer readable medium tangibly embodies a program, functions, and/or instructions that are executable by the computer system 100 to perform methods as described herein.

The computer system 100 may be connected to a network, including local area networks (LANs) 152, wide area networks (WANs) 154, portions of the Internet such as a private Internet, a secure Internet, a value-added network, or a virtual private network. Suitable network clients 156 may include personal computers, laptops, workstations, disconnectable mobile computers, mainframes, information appliances, personal digital assistants, handheld and/or embedded processing systems, or a CT Scanner as described above in relation to element 131. The signal lines that support communications links to clients 156 may include twisted pair, coaxial, or optical fiber cables, telephone lines, satellites, microwave relays, modulated AC power lines, and other data transmission “wires” known to those of skill in the art. Further, signals may be transferred wirelessly through a wireless network or wireless LAN (WLAN) using any suitable wireless transmission protocol, such as the IEEE series of 802.x standards. Although particular individual and network computer systems and components are shown, those of skill in the art will appreciate that the techniques described herein also work with a variety of other networks and computers.

A temporal subtraction image may be obtained by subtraction of a previous image from a current one and may be used for enhancing interval changes on medical images by removal of most normal structures that are common to both images. For example, a subtraction technique applied to CT angiography (CTA) may compare several CT images of arterial and venous vessels taken over a period of time. CTA images are acquired as a temporal sequence. Angiography images may also be taken while a bolus of contrast material proceeds through a vessel. The image contrast of an opacified vessel at any particular location usually changes from one image to the next, i.e., the image contrast of the vessel is a function of time. By removing the common structures of the several CTA images, interval changes may improve detection of embolisms, stenosis, aneurysms, dissection, intracranial arteriovenous malformations, atherosclerotic disease, thrombosis, or other abnormalities. An angiography technique for measuring blood flow rate is disclosed in U.S. Pat. No. 5,150,292, the entire disclosure of which is hereby expressly incorporated by reference herein.

Other examples of interval changes include the formation of new lesions and tumors, or changes to existing abnormalities. Subtraction methods such as temporal subtraction, digital subtraction angiography imaging, bilateral subtraction, and contralateral subtraction may be applied to clinical cases to improve radiologists' diagnostic accuracy and reduce their reading time. With the subtraction method, an image-warping technique may accurately deform the previous image to match or “register” the current image so that correspondence between not only the image structures, but also the image basic units, e.g., voxels (3-D images) or pixels (2-D images) may be achieved. Increasing the accuracy of image registration may reduce the potential for misregistration or subtraction artifacts in a resulting subtraction image. Further, subtraction images, such as temporal subtraction images from multiple-detector CT (MDCT) volume images as used in thoracic examinations, may employ a 3-D registration and warping technique between the current and previous images.

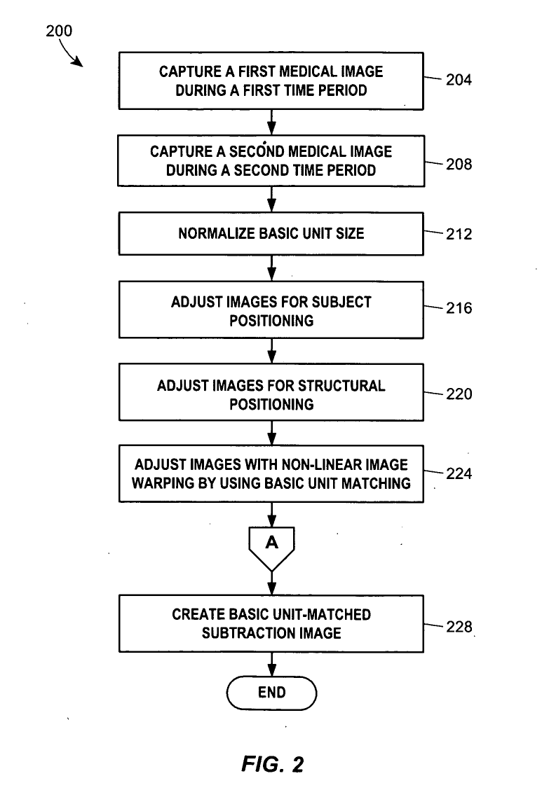

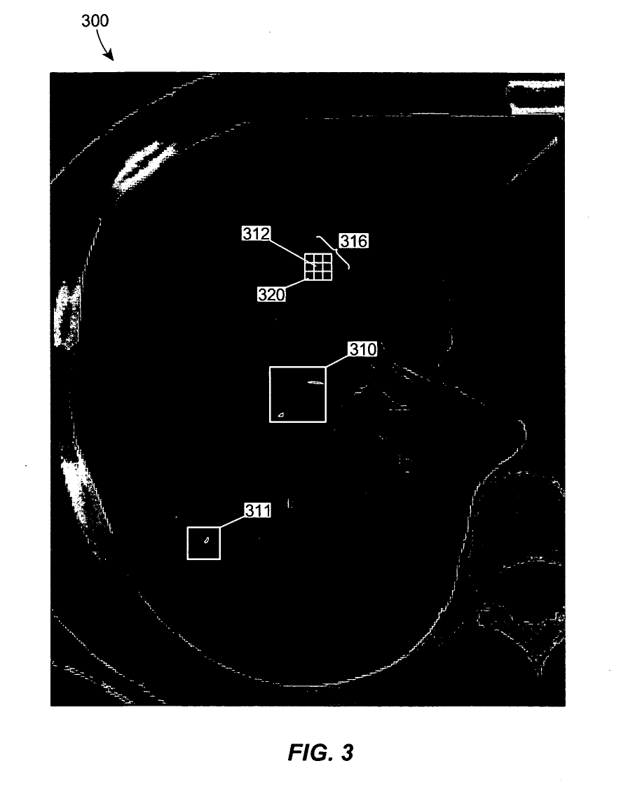

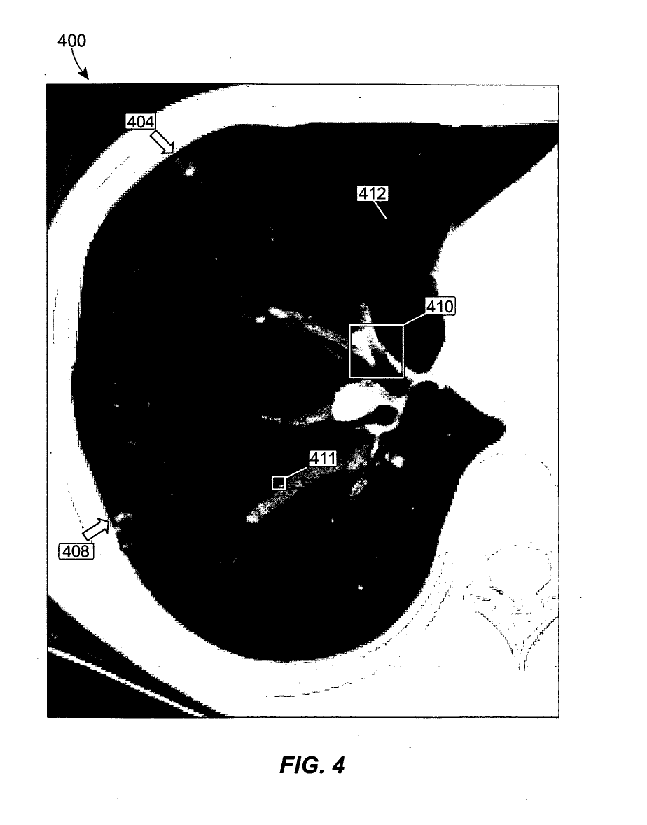

Turning to FIG. 2, a method 200 for accurately registering and subtracting a pair of medical images using basic unit matching and image subtraction is disclosed. The method 200 may be employed with ordinary computer-aided detection or diagnosis (CAD), CAD that is specialized to read subtraction images, or in any other technique for analyzing medical images. At step 204, the method 200 may capture a first medical image 300 (FIG. 3) during a first time period. At step 208, the method 200 may capture a second medical image 400 (FIG. 4) during a second time period. An image 300, 400 may be a representation of a physical scene, in which the image 300, 400 has been generated by some imaging technology. The initial medium on which an image 300, 400 is recorded may be a computer-readable medium, an electronic solid-state device, a photographic film, a photostimulable phosphor, or some other medium or device. The recorded image 300, 400 may also be converted into digital form by a combination of electronic (e.g., a Charged Coupled Device) or mechanical/optical means (e.g., digitizing a photographic film or digitizing the data from a photostimulable phosphor). The image 300, 400 may be recorded in any number of dimensions, for example, one (e.g., acoustic signals), two (e.g., X-ray radiological images) or more (e.g., nuclear magnetic resonance images).

Each of the first 300 and second 400 medical images may include a plurality of basic units. In one embodiment employing 3-D medical images, the basic units comprise voxels. In a further embodiment employing 2-D medical images, the basic units comprise pixels. A voxel is a unit of graphic information that defines a point in 3-dimensional space, whereas a pixel defines a point in 2-dimensional space.

In addition to location information, each basic unit may also include a value, for example, a measure of color or density. In specialized medical imaging processes, a basic unit value may be a value from a quantitative scale that was measured by the imaging process. For example, in CT, the voxel value may be a measure of radiodensity expressed in Hounsfield units (a quantitative measure of radiodensity). However, in Dynamic Contrast MRI, the voxel value may be associated with a measure of kinetic parameters associated observed tissues while a bolus of contrast material proceeds through the imaged subject. In MRI, sonography, PET, or any other imaging technique, a basic unit value may be a measure of signal or image intensity. Of course, many other values may be associated with a medical image basic unit.

The first 300 and second 400 images may be captured to obtain images containing basic units of approximately the same size. In one embodiment, the first 300 and second 400 images are both captured with identical devices. In a further embodiment, different exposure conditions between the first 300 and second 400 images, whether from different devices or other exposure conditions, may be corrected by adjusting the basic unit values in the images so that a majority of the basic units between the first 300 and second 400 images match. The second medical image 400 may include abnormalities 404, 408 that were not present in the first medical image 300 that may indicate lesions, aneurysms, or other maladies. In one embodiment, the first 300 and second 400 medical images may be captured using any suitable medical imaging equipment, as previously discussed. As used herein, when applied to an imaging subtraction technique, the first image may represent a “previous” image, while the second image may represent a “current” image.

When the method 200 employs a CT scanner 131, the scanner 131 may be a multi-slice CT scanner 131 and may include any suitable number of row detectors. Suitable CT scanners may be the LightSpeed® QXi scanner manufactured by General Electric Medical Systems of Waukesha, Wis., USA, or the Aquilion® scanner manufactured by Toshiba of Japan. Further, the CT scanner 131 may capture slice images in various matrix and voxel sizes. In one embodiment, a matrix size for each slice image may be 512×512 and the voxel size may range from 0.488 mm to 0.712 mm (mean, 0.646 mm) on the x and y axes, and 5.00 mm or 1.00 mm on the z axis. Of course, any matrix and voxel or pixel size may be employed to produce a slice image for use with the method 200. When slice images with generally a 5-mm or greater slice thickness are employed, a z axis resolution may be increased by interpolating images between slice images.

At step 212, a basic unit of the first 300 and second 400 medical images may be normalized. The images 300, 400 may be 3-dimensional and the basic unit may be a voxel having a position represented by an x-axis value, a y-axis value, and a z-axis value. The images 300, 400 may also be 2-dimensional and the basic unit may be a pixel having an x-axis value and a y-axis value. In one embodiment, a value associated with the basic unit in one or both of the first 300 and second 400 images may be normalized. For example, in CTA, the measure of radiodensity may be normalized for all basic unit values. Of course, other types of medical images may have various values associated with the basic units that may be normalized. Normalization of the basic units may be required when the basic unit sizes or values in the first 300 medical image are different from the second 400 medical image basic units. The basic units may be normalized using any suitable technique. In one embodiment, the basic units may be normalized by linear interpolation.

At step 216, the method 200 may adjust the first 300 and second 400 images for differences in subject positioning by calculating a global shift vector. Where CT images are employed, the global shift vector may be determined for each of the first 300 or second 400 image slices. In one embodiment, a 2-dimensional template matching technique based on a 2-dimensional cross-correlation method may be employed as generally described in “Development of 3D CT temporal subtraction based on nonlinear 3D image warping technique,” by T. Ishida, S. Katsuragawa, H. Abe, K. Ashizawa, and K. Doi in Proc. The 91st Radiological Society of North America (RSNA), 111, Chicago, USA, 2005, the entire disclosure of which is hereby incorporated by reference herein. In a further embodiment, blurred images may be obtained from the first and second images by a Gaussian filter. The images may be modified to reduce computation time or to emphasize larger structures in the images. For example, the images may begin with a matrix size of 512×512 and be reduced in the x-y plane to 128×128. In each second 400 image, an area may be selected as a template image 410. A corresponding template image 310 on the first 300 image may be moved to determine the global shift vector. The global shift vector may be indicated by a template location with a maximum of the 2-dimensional cross-correlation value that may be a measure of the similarity between the first 300 and second 400 images.

At step 220, a registration between the first 300 and second 400 images may be further refined by adjusting the images resulting from step 216. For example, the images may be registered locally to correct warping or deformation between the first 300 and second 400 image. In one embodiment, the method 200 may employ a local matching technique to determine local shift vectors for each basic unit of the first or second image. When 3-D images are subtracted using the method 200, a local shift vector for each image voxel may be determined.

One embodiment determines local shift vectors as generally described in “Temporal subtraction on 3D CT images by using nonlinear image warping technique,” by T. Ishida, S. Katsuragawa, I. Kawashita, H. Kim, Y. Itai, K. Awai, Q. Li, and K. Doi, in Int. J. CARS, 1, pp. 468, 2006, the entire disclosure of which is hereby incorporated by reference herein. In a further embodiment, a template area of interest 411 may be located within the second 400 image and a search area of interest 311 may be located within the first image 300. The matrix sizes of the template 411 and search 311 areas of interest may be any size within the respective image. For example, the search area of interest 311 may be twice as large as the template area of interest 411. In one embodiment, in a 3-D image, the search area of interest 311 may be 64×64×32 voxels and the template area of interest 411 may be 32×32×16 voxels. Of course, the template 411 and search 311 areas of interest as shown in FIGS. 4 and 3, respectively, are exaggerated for illustration only. The areas of interest 411, 311 may be smaller or larger as compared to the corresponding images 400, 300. A larger search area of interest 311 may increase the likelihood that a basic unit within the template area of interest 411 may correspond to a basic unit within the search area of interest 311. Distances between the template 411 and search 311 areas of interest within their corresponding images may also be twice as large in the x-y plane as in the z axis. A 3-D cross-correlation value for each template-search area of interest pair 411, 311 may be calculated with translation of a template area of interest 411 within a corresponding search area of interest 311. A local shift vector may result for each template-search area of interest pair 411, 311 when a 3-D cross-correlation value reaches a maximum.

At step 224, the first 300 and second 400 images may be further registered by adjusting the images with 3-D non-linear image warping by using 3-D voxel matching. In one embodiment, a shift vector for image warping may be obtained by a combination of the global shift vector as described in step 216 and the local shift vector as described in step 220. The resulting shift vectors may represent the extent of warping or deformation of the first image 300 relative to the second image 400. However, the orientation and amplitude of a single shift vector may change in comparison to an adjacent shift vector due to noise in some types of medical images, for example, MDCT images. To remedy an unwanted shift due to image noise, the method may employ a 3-D elastic matching method for smoothing shift vectors as generally disclosed in “3D elastic matching for temporal subtraction employing thorax MDCT image,” by Y. Itai, H. Kim, S. Ishikawa, S. Ishikawa, T. Ishida, I. Kawashita, K. Awai, Q. Li, and K. Doi, in Proc. of the World Congress on Medical Physics and Biomedical Engineering, pp. 2181-2191, 2006, the entire disclosure of which is hereby incorporated by reference herein.

A 2-D elastic matching method, may obtain the shift vector corresponding to a specific pixel that preserves a high cross-correlation value and high consistency over the other shift vectors associated with other pixels. In a 3-D space, a 3-D elastic matching technique be employed to similar effect. In the elastic matching method, the smoothed shift vector may be obtained by minimizing a cost function that is a weighted sum of an internal and an external energy. The internal energy may be the squared sum of the first- and second-order derivative values of the shift vectors because smoother shift vectors correspond to smaller internal energy. In one embodiment, the external energy may be equal to the negative value of the 3-D cross-correlation value that is obtained with the template-search area of interest pair, as described above. A shift vector with a large correlation value may provide a small external energy. Therefore, with the 3-D elastic matching technique, the smoothed shift vector may be obtained by taking into account not only the similarity between the second 400 and the first 300 images, but also the consistency of the shift vectors. With the smoothed shift vectors obtained, the shift vectors in all voxels in the previous image may be determined by use of a tri-interpolation in the case of 3-D images, or another interpolation method with other types of images. Interpolation of the shift vectors to the images may result in a warped image that accounts for deformities between the first 300 and second 400 medical images.

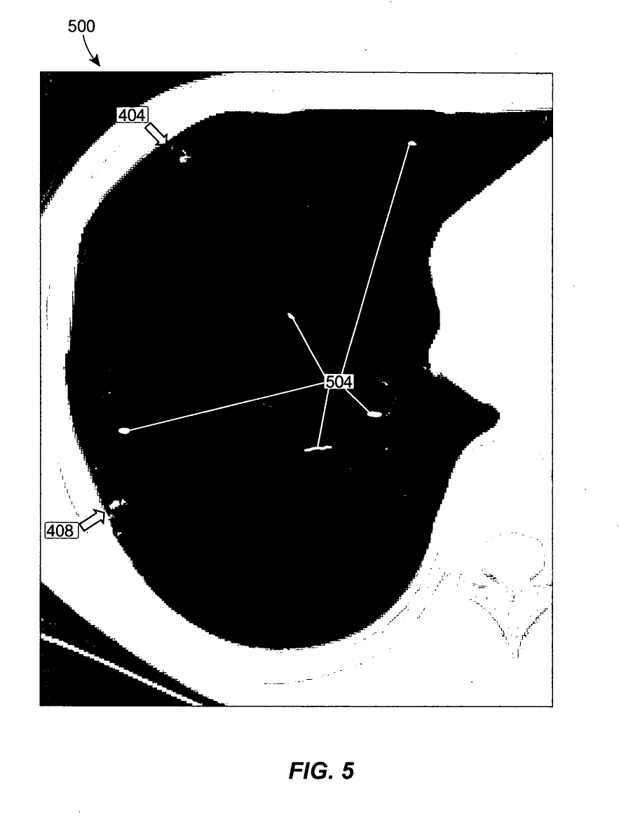

After warping the first (or previous) image 300, the general appearance of the warped previous image 300 may be very similar to that of the second 400 (or current) image. With reference to FIG. 5, despite warping the first or previous image as described in blocks 212-224 of FIG. 2, any temporal subtraction image 500 obtained by the subtraction of the warped or non-warped first image 300 from the second (or current) image 400 may contain subtraction artifacts 504.

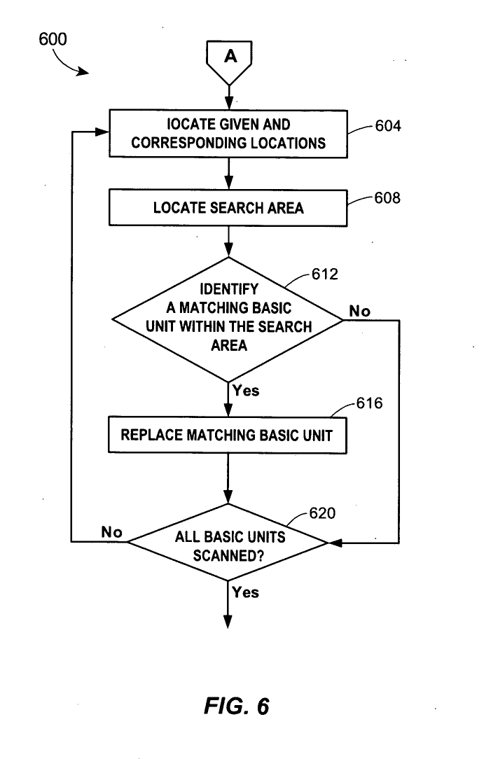

Continuing with block 224, with reference to FIG. 6, a basic unit matching technique 600 may be described to further register the first 300 and second 400 images and remove or reduce subtraction artifacts. In one embodiment, the basic unit matching technique may accurately match a basic unit between a first 300 and second 400 image. At step 604, for a given location 412 in the second 400 image, the method 200 may locate a corresponding location 312 in the first 300 warped or non-warped image. In one embodiment, the given location 412 and the corresponding location 312 may each be located in a substantially identical area of the first 300 and second 400 images. At step 608, the method 600 may locate a search area 316 or “kernel” surrounding the corresponding location 312. The search area 316 as illustrated in FIG. 3 is exaggerated for the sake of clarity and explanation. Generally, the search area 316 may be a volume of 3×3×3 basic units (for a 3-D image where the basic units are voxels). Depending on the resolution of the first 300 and second 400 images, the search area 316 may be very small in comparison to the entire image 300. In a further embodiment, the size of the search area 316 may be made smaller or larger and may encompass a variety of shapes, as further explained in relation to block 228, below.

At block 612, the method 600 may identify a basic unit within the search area 316 that most closely matches the basic unit identified by the given location 412. In one embodiment, the matching basic unit 320 value may be nearly identical to the given location basic unit 412. For example, where the images 300, 400 are CT images, the Hounsfield value of the matching basic unit 320 and the given location basic unit may be substantially identical. In a further embodiment, the matching basic unit 320 size (area or volume) may be nearly identical to the given location basic unit 412. Further, the given location basic unit 412 value and the matching basic unit 320 value may be nearly identical for purposes of matching if the difference is statistically insignificant. For example, the difference may be statistically insignificant if it is within an average visual noise level of the first 300 or second image 400. If a matching basic unit 320 is found, then the method proceeds to block 616, otherwise, the method 600 proceeds to block 620.

At block 616, the method 600 may replace the given location basic unit 412 with the matching basic unit 320 found at block 612 or otherwise normalize any basic unit that is not an abnormality 404, 408. In one embodiment, the method 600 may modify the values of the given location basic unit 412 to match the values of the matching basic unit 320. In a further embodiment, the method 600 may cut and paste the matching basic unit 320 from the first image 300 to the given location basic unit 412. In a still further embodiment, the method 600 may replace the given location basic unit 412 with the difference between the values of the given location basic unit 412 and the matching basic unit 320. In a still further embodiment, the method 600 may modify the value of all matching basic units to the same value, for example, zero, thereby representing all matching basic units in a resulting subtraction image as identical. Of course, other embodiments may encompass other techniques to normalize any basic unit of either a warped or non-warped first 300 or second 400 image to remove any basic unit that is common to both images 300, 400 thus leaving the basic units that include an abnormality 404, 408 generally unmodified.

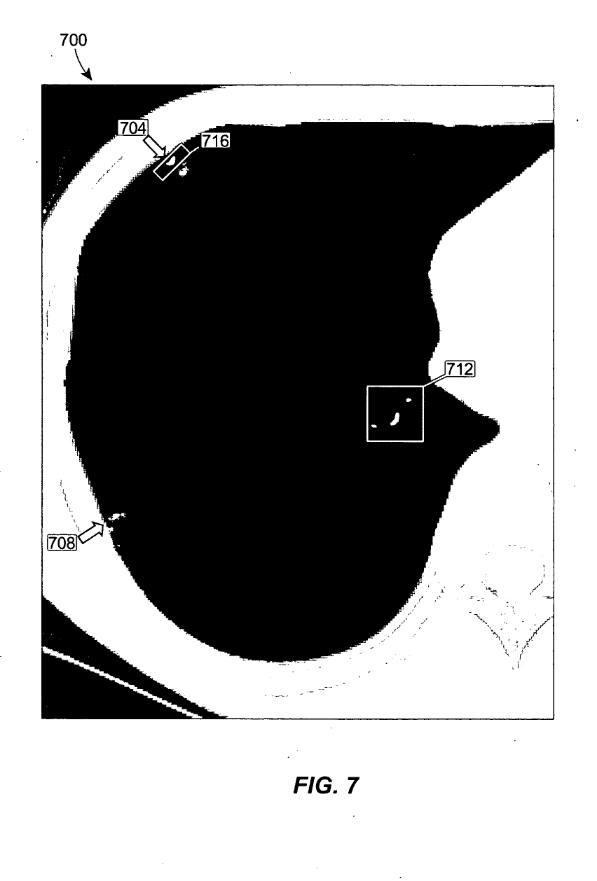

Returning to FIG. 2, at block 228, the method 200 may create a subtraction image 700 (FIG. 7). In one embodiment, if, at block 616, the method 600 modifies the values of the basic units of one of the images to match the other, then, at block 228, the method 200 may output the image containing the modified basic units as the subtraction image 700. In a further embodiment, if, at block 616, the method 600 cuts and pastes the matching basic unit 320 from one of the first 300 or second 400 images to the corresponding, matched basic unit of the other image 300, 400, then, at block 228, the method 200 may output the image containing the pasted basic units as the subtraction image 700. In a still further embodiment, if, at block 616, the method 600 replaces all of the matching basic units within either the first 300 or second 400 image with the difference between the values of the matching basic units, then, at block 228, the method 200 may subtract the image containing the replaced basic units from the unmodified image to create the subtraction image 700. Other embodiments may subtract a warped or non-warped first previous image 300, as described in relation to blocks 212-224 above, from a second or current image 400 to produce a subtraction image 700. The method 200 may then optionally apply the basic unit matching technique described in relation to FIG. 6 to further refine and produce a temporal subtraction image.

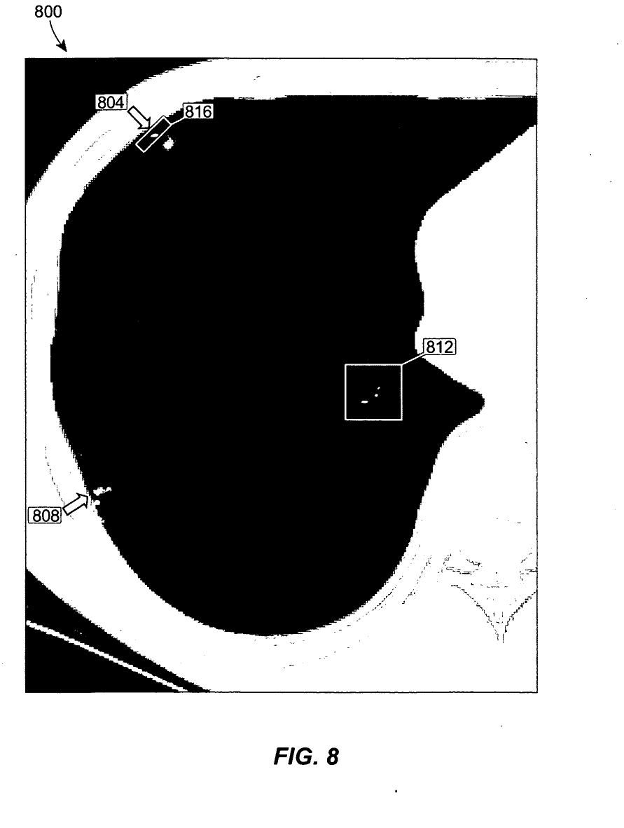

With reference to FIGS. 7 and 8, the size of the search area 316, as described in relation to block 608 above, may be made smaller or larger and may encompass a variety of shapes. For example, a larger search area, such as 5×5×5, may decrease the detection sensitivity for small abnormalities while increasing the elimination of subtraction artifacts 504. On the other hand, a smaller search area may increase the detection sensitivity for small abnormalities while decreasing the elimination of subtraction artifacts 504. FIG. 8 illustrates a larger search area voxel-matched subtraction image that may be produced with a larger search area 316 than the subtraction image of FIG. 7. A smaller search area subtraction image 700 may include areas, for example, area 712, that includes subtraction artifacts. In comparison, a larger search area subtraction image 800 may eliminate or reduce the same subtraction artifacts in a similar area 812. However, the smaller search area subtraction image 700 may also detect a larger portion 716 of an abnormality 704 than the same portion 816 of a larger search area subtraction image 800.

The search area 316 size may be automatically or manually selected depending on a desired sensitivity and the presence of subtraction artifacts 504. Generally, when the method 600 employs a search area 316 that is 3×3×3 basic units, abnormalities 404, 408 of 2 mm or larger may be detected, although smaller abnormalities 404, 408 may be present and detectable in subtraction images employing a smaller or larger search area 316. Additionally, the search area 316 may encompass any form including a sphere, a cylinder, a square (where the first 300 and second 400 images are 2-D), or any irregular shape.

The method 200 may also cycle through the number of search area 316 sizes to determine a size that may result in a desirable subtraction image. For example, two temporal subtraction images produced with differing search areas may be produced. The method 200 may compare the subtraction images to determine which image includes the least amount of subtraction artifacts while producing the most accurate contrast image to detect abnormalities. In one embodiment, the method 200 may buffer a number of subtraction images before display to determine the most accurate or desirable image. Upon determining an optimal search area 316, the method may re-execute a subtraction block to produce a subtraction image as described in relation to block 228, above.

The basic unit-matching technique described above may also include a user interface that is responsive to user inputs in various portions of the user interface on the display 116 of the computer system 100, on the CT Scanner 131, or other devices. For example, one portion of an interface may render a sequence of tomographic sections. These tomographic sections may be maximum intensity projection (MIP) images or 3D images or slices of 3D images. The orientations or views of these sections or images may be manipulated by an input device 120, for example. The section or sections displayed may be selectable by an input device 120 and a portion of the interface may render a subtraction image. In one embodiment, clicking on a button using a mouse 124, or similar control, in a portion of the user interface causes the subtraction image to be replaced by a corresponding basic unit matched subtraction image. In a further embodiment, the basic unit matched subtraction image is only displayed while the control is activated. In a still further embodiment, a control of the graphical user interface may also allow the user to vary the size of a search area 316 as the basic unit matched subtraction image corresponding to the selected search area size is displayed. In a still further embodiment, a sub-portion (e.g., a rectangular or circular sub-portion) of the subtraction image is replaced by a corresponding sub-portion of the basic unit matched subtraction image. In a still further embodiment, the position of the sub-portion may be moved about the image by the user through an input device 120. In a still further embodiment, the size and shape of the sub-portion may also be controlled by the user.

With the basic unit-matching technique described above, subtraction artifacts may be removed due to very slight differences in the size, shape, and location of normal anatomic structures. Thus, the technique may produce smooth temporal subtraction images except for new abnormalities, as illustrated in FIGS. 7 and 8. In addition, the majority of the noise in medical images may be removed by use of the technique, as shown by the smooth background in the temporal subtraction images of FIGS. 7 and 8.

The previously-described techniques include several embodiments, including a number of features, functions, and method blocks. Not all features and functions are required for every embodiment. The features discussed herein are intended to be illustrative of those features that may be implemented; however, such features should not be considered exhaustive of all possible features that may be implemented in a device configured in accordance with the embodiments. Further, the described method blocks may be executed in any order to produce a temporal subtraction image by the techniques disclosed herein. Moreover, the herein described embodiments are illustrative and not limiting; the embodiments are defined and limited only by the following claims.

We claim:

1. A method for producing a basic unit-matched temporal subtraction image comprising:
capturing a first medical image including a plurality of first basic units during a first time period;
capturing a second medical image including a plurality of second basic units during a second time period, wherein the first and second medical images comprise an approximately identical subject;
locating a plurality of given location basic units in the plurality of second basic units within the second medical image;
locating a plurality of corresponding location basic units in the plurality of first basic units within the first medical image, wherein each of the plurality of corresponding location basic units corresponds to one of the plurality of given location basic units, and each pair of the corresponding location basic units and given location basic units are located at a substantially identical location within the first and second medical images;
identifying a plurality of search areas in the first medical image, each of the plurality of search areas centered on one of the plurality of corresponding location basic units;
identifying a plurality of matching basic units within the plurality of search areas, wherein each matching basic unit corresponds to one of the plurality of given location basic units, and each pair of the matching basic units and given location basic units are substantially identical; and
creating the basic unit-matched temporal subtraction image from the plurality of matching basic units.

2. The method of claim 1, further comprising registering the first and second medical images.

3. The method of claim 2, wherein registering the first and second medical images comprises:
normalizing a value of each of the plurality of first basic units and the plurality of second basic units;
correcting the first medical image for subject positional differences between the first and second medical images.

4. The method of claim 1, further comprising setting each of the plurality of matching basic unit values to zero.

5. A method for producing a voxel-matched subtraction image comprising:
capturing a first image including a plurality of first voxels;
capturing a second image including a plurality of second voxels, wherein the first and second images comprise an approximately identical subject;
locating a plurality of given location voxels in the plurality of second voxels within the second image;
locating a plurality of corresponding location voxels in the plurality of first voxels within the first image, wherein each of the plurality of corresponding location voxels corresponds to one of the plurality of given location voxels, and each pair of the corresponding location voxels and given location voxels are located at a substantially identical location within the first and second images;
identifying a plurality of search areas in the first image, each of the plurality of search areas containing one of the plurality of corresponding location voxels;
identifying a plurality of matching voxels within the plurality of search areas, wherein each matching voxel corresponds to one of the plurality of given location voxels, and each pair of the matching voxels and given location voxels are substantially identical; and
creating the voxel-matched subtraction image from the plurality of matching voxels.

6. The method of claim 5, further comprising registering the first and second images.

7. The method of claim 6, wherein registering the first and second images comprises:
normalizing a value of each of the plurality of first voxels and the plurality of second voxels;

8. The method of claim 5, wherein creating the voxel-matched subtraction image comprises:
for each pair of the matching voxels and given location voxels, replacing the corresponding location voxel with the matching voxel; and
subtracting the corresponding location voxels from the given location voxels.

9. A method for producing a voxel-matched subtraction image comprising:
capturing a first image including a plurality of first voxels;
capturing a second image including a plurality of second voxels, wherein the first and second images comprise an approximately identical subject;
locating a plurality of given location voxels in the plurality of second voxels within the second image;
for each given location voxel, locating a corresponding location voxel in the plurality of first voxels within the first image, wherein each pair of the corresponding location voxels and given location voxels are located at a substantially identical location within the first and second images;
identifying a plurality of search areas in the first image, wherein each of the plurality of search areas contains a corresponding location voxel and corresponds to one of the plurality of given location voxels;
determining whether a matching voxel is present within each of the plurality of search areas;
for each given location voxel having a matching voxel, replacing the corresponding location voxel with the matching voxel; and
subtracting the corresponding location voxels from the given location voxels.

10. The method of claim 9, wherein a voxel is matching if the matching voxel and given location voxel are substantially identical in value.

11. The method of claim 9, wherein a voxel is matching if the matching voxel and given location voxels are identical in value.
